(19) United States
(12) Patent Application Publication
(10) Pub. No.: US 2017/0316340 A1
(43) Pub. Date: Nov. 2, 2017

(54) HYPERPLANE DETERMINATION THROUGH SPARSE BINARY TRAINING VECTORS

(71) Applicant: Hewlett Packard Enterprise Development LP, Houston, TX (US)

(72) Inventors: Mehran Kafai, Redwood City, CA (US); Kave Eshghi, Los Altos, CA (US)

(21) Appl. No.: 15/142,798

(22) Filed: Apr. 29, 2016

(51) Int. Cl. G06N 99/00

(52) U.S. Cl. CPC G06N 99/005

(57) ABSTRACT

In some examples, a system includes an access engine and a hyperplane determination engine. The access engine may access a training vector set that includes sparse binary training vectors and a set of labels classifying each of the sparse binary training vectors through a positive label or a negative label. The hyperplane determination engine may initialize a candidate hyperplane vector and maintain a scoring vector including scoring vector elements to track separation variances of the sparse binary training vectors with respect to the candidate hyperplane vector. Through iterations of identifying, according to the scoring vector, a particular sparse binary training vector with a greatest separation variance with respect to the candidate hyperplane vector, the hyperplane determination engine may incrementally update the candidate hyperplane vector and incrementally update the scoring vector to adjust separation variances affected by updates to the candidate hyperplane vector.

### BACKGROUND

With rapid advances in technology, computing systems are increasingly prevalent in society today. Vast computing systems execute and support applications that communicate and process immense amounts of data, many times with performance constraints to meet the increasing demands of users. Increasing the efficiency, speed, and effectiveness of computing systems will further improve user experience.

### BRIEF DESCRIPTION OF THE DRAWINGS

Certain examples are described in the following detailed description and in reference to the drawings.

FIG. 1 shows an example of a system that supports hyperplane determination through sparse binary training vectors.

FIG. 2 shows an example of an architecture that supports hyperplane determination through sparse binary training vectors.

FIG. 3 shows a flow chart of an example method for hyperplane determination through sparse binary training vectors.

FIG. 4 shows a flow chart of another example method for hyperplane determination through sparse binary training vectors.

FIG. 5 shows an example of a system that supports hyperplane determination through sparse binary training vectors.

### DETAILED DESCRIPTION

The discussion below refers to hyperplanes. A hyperplane may refer to a subspace of a vector space, and a separating hyperplane may refer to a hyperplane that separates different vectors in the vector space. In that regard, a separating hyperplane may divide two different classes of vectors, and separating hyperplanes may be determined (e.g., trained) through machine-learning operating on a training vector set.

Examples consistent with the present disclosure may support determination of separating hyperplanes through sparse binary training vectors. The hyperplane determination features described herein may leverage the sparse and binary characteristics of such training vectors, which may provide for reduced computational requirements in determining separating hyperplanes of training vector sets. As described in greater detail below, the hyperplane determination features described herein may incrementally update various data structures used in hyperplane computations, such as a candidate hyperplane vector trained during the determination process as well as a scoring vector used to track separation variances of the training vectors from the candidate hyperplane vector. These incremental updates may be computationally efficient, and the hyperplane determination features described herein may increase computer performance and reduce resource consumption.

Incremental updates to a scoring vector and a candidate hyperplane vector in hyperplane determinations may be particularly suited for sparse binary training vectors, as vector product operations for such training vectors may be efficiently implemented. For instance, computations involving the 0-value vector elements of the training vectors may be disregarded or omitted, as these product or sum computations with 0-value vector elements may have no effect on the outcome of an overall vector product or vector sum operation. Leveraging such characteristics, the hyperplane determination features described herein may be more computationally efficient than other hyperplane determination mechanisms requiring complex and costly matrix or vector product operations, especially as the number of training vectors increases into the millions, tens of millions, and more.

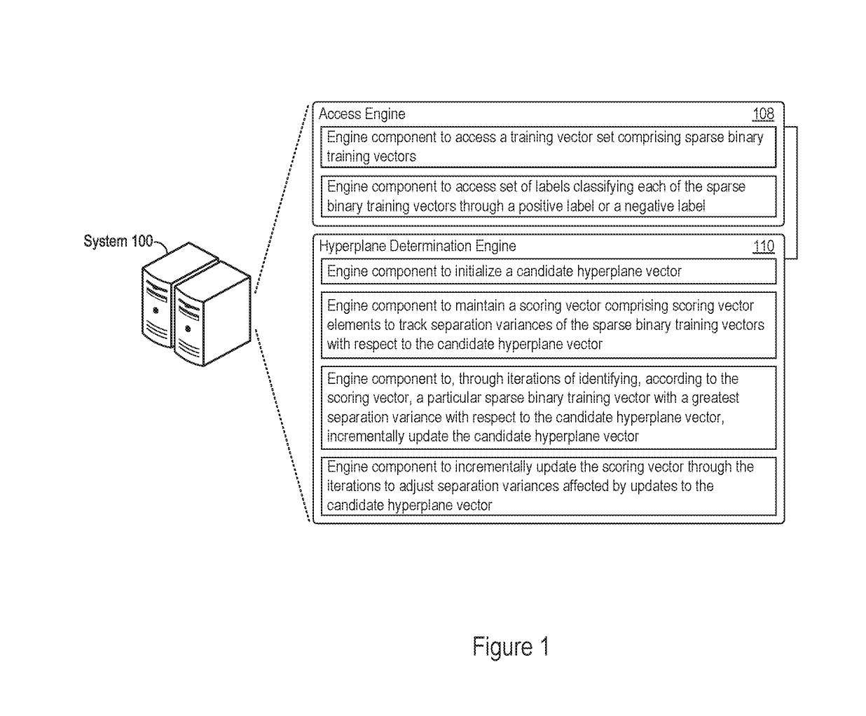

FIG. 1 shows an example of a system 100 that supports hyperplane determination through sparse binary training vectors. The system 100 may take the form of any computing system and may include a single or multiple computing devices such as servers, compute nodes, desktop or laptop computers, smart phones or other mobile devices, tablet devices, systems-on-a-chip, embedded controllers, and more.

The system 100 may determine a hyperplane that separates vectors of a first label (e.g., a positive label) from vectors of a second label (e.g., a negative label). In that regard, the system 100 may determine a separating hyperplane, for example with respect to a received training vector set. Put another way, the system 100 may adaptively update the separating hyperplane through iterations of processing training vectors, and thus “train” the separating hyperplane.

The system 100 may determine a separating hyperplane for sparse binary training vectors. A binary vector may refer to a vector where each vector element of the vector includes a ‘0’ value or a ‘1’ value. A sparse vector may refer to a vector where the number of non-zero vector elements (e.g., with a ‘1’ value) is significantly less than the total number vector elements of the sparse vector. Described differently, a sparse vector may be a vector where a significant majority of the vector elements have a ‘0’ value. Vector sparsity may be measured as a ratio of the non-zero to total elements of a vector, and sparse vectors may be characterized as vectors with a sparsity less than a sparsity threshold (e.g., less than 1.0% or any other configurable threshold).

For training vector sets comprising sparse binary training vectors, the system 100 may leverage the binary and sparse nature of the training vectors to determine a separating hyperplane with increased efficiency. In general, the system 100 may reduce resource consumption by performing computations tailored to the non-zero elements of the sparse binary training vectors, but foregoing or determining not to perform computations involving vector elements with a ‘0’ value. In particular, the system 100 may apply such computation reduction mechanisms for hyperplane determinations for a training vector set including sparse binary training vectors. In doing so, the system 100 may achieve the accuracy of existing classifiers, such as the perceptron algorithm and the MinOver algorithm, but do so at increased efficiency. In some examples, the system 100 supports machine-learning and classification of training vector sets with millions of training vectors, and more, which may be impractical or near-impossible for traditional classifiers.

The system 100 may implement various engines to provide or support any of the features described herein. In the example shown in FIG. 1, the system 100 implements an access engine 108 and a hyperplane determination engine 110. The system 100 may implement the engines 108 and 110 (including components thereof) in various ways, for example as hardware and programming. The programming for the engines 108 and 110 may take the form of processor-executable instructions stored on a non-transitory machine-readable storage medium, and the processor-executable instructions may, upon execution, cause hardware to perform any of the features described herein. In that regard, various programming instructions of the engines 108 and 110 may implement engine components to support or provide the features described herein.

The hardware for the engines 108 and 110 may include a processing resource to execute programming instructions. A processing resource may include various number of processors with single or multiple cores, and a processing resource may be implemented through a single-processor or multi-processor architecture. In some examples, the system 100 implements multiple engines using the same system features or hardware components (e.g., a common processing resource).

The access engine 108 and hyperplane determination engine 110 may include components to support determination of a separating hyperplane for a training vector set that includes sparse binary training vectors. In the example implementation shown in FIG. 1, the access engine 108 includes engine components to access a training vector set comprising sparse binary training vectors that characterize elements of a physical system and access a set of labels classifying each of the sparse binary training vectors through a positive label or a negative label. The positive and negative labels may be a ‘1’ value and a ‘−1’ value respectively, for example.

The hyperplane determination engine 110 may include the engine components shown in FIG. 1 to initialize a candidate hyperplane vector; maintain a scoring vector comprising scoring vector elements to track separation variances of the sparse binary training vectors with respect to the candidate hyperplane vector; through iterations of identifying, according to the scoring vector, a particular sparse binary training vector with a greatest separation variance with respect to the candidate hyperplane vector, incrementally update the candidate hyperplane vector and incrementally update the scoring vector to adjust separation variances affected by updates to the candidate hyperplane vector.

These and other aspects of hyperplane determination using sparse binary training vectors are discussed in greater detail next.

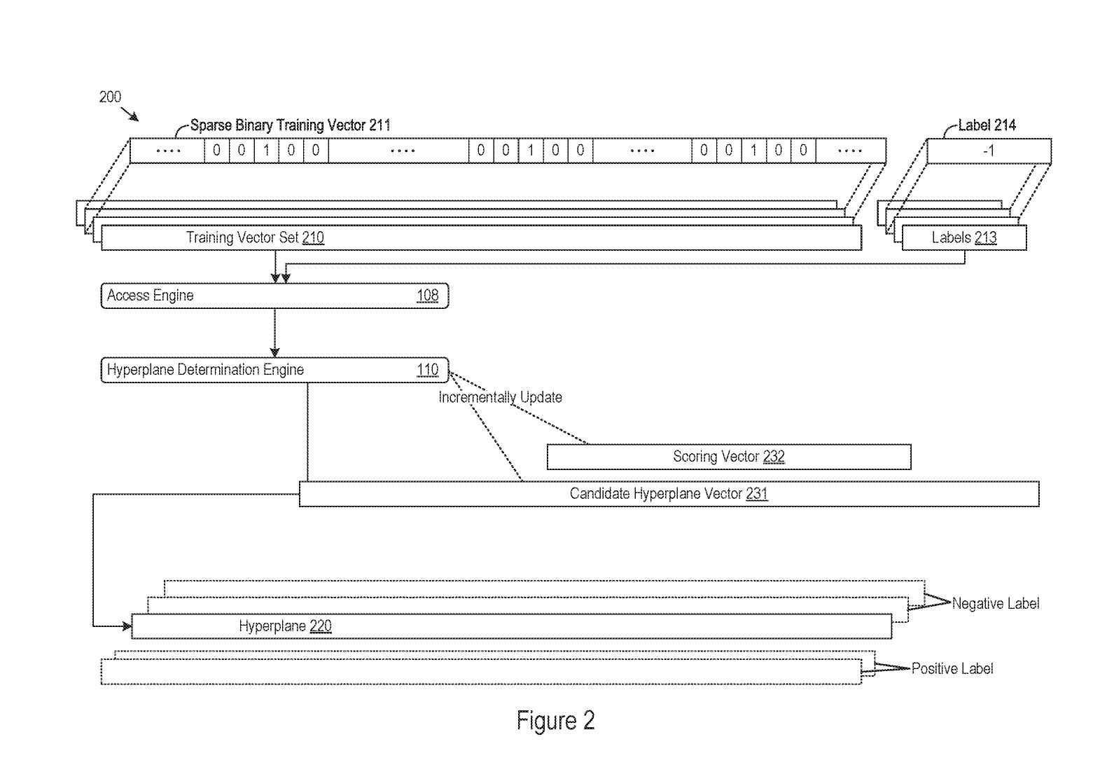

FIG. 2 shows an example of an architecture 200 that supports hyperplane determination through sparse binary training vectors. The architecture 200 in FIG. 2 includes the access engine 108 and the hyperplane determination engine 110. The access engine 108 may receive a training vector set 210 to train a classifier. The classifier may be trained and used in various applications on physical systems. As such, the training vector set 210 may include training vectors characterizing objects or elements with respect to any of these physical systems, and the access engine 108 and hyperplane determination engine 110 may be implemented by or for such physical systems. Example physical systems include systems for image recognition processing, fraud detection, high-frequency trading, medical diagnostics, anomaly detection in video streams, and countless other applications. Real-time applications may require both speed and accuracy in classifications, and the access engine 108 and the hyperplane determination engine 110 may support hyperplane determination and classifier training to meet the operational requirements of such systems and applications.

The training vector set 210 may include multiple sparse binary training vectors. One example training vector is shown in FIG. 2 as the sparse binary training vector 211. The access engine 108 may receive the training vector set 210 from another system or other logic that generates sparse binary training vectors. In some implementations, the sparse binary training vectors included in the training vector set 210 include feature vectors generated using concomitant rank order (CRO) hash sets.

The access engine 108 may also receive a set of labels 213 for the training vector set 210. The labels may 213 be specify any number of classes that the training vector set 210 is divided into. For binary classification training, the labels 213 may include a positive labels (e.g., a ‘1’ value) and negative labels (e.g., a ‘−1’ value). The particular label applicable to a sparse binary training vector indicates the class that the sparse binary training vector belongs to. In the example shown in FIG. 2, the set of labels 213 includes the example label for the sparse binary training vector 211, which is shown in FIG. 2 as the label 214 with a ‘−1’ value.

From the received training vector set 210 and set of labels 213, the hyperplane determination engine 110 may determine a separating hyperplane for the training vector set 210. In FIG. 2, the hyperplane determination engine 110 determines the hyperplane 220 as the separating hyperplane for the training vector set 210. In that regard, the hyperplane 220 may separate the sparse binary training vector(s) of the training vector set 210 classified with the positive label from the sparse binary training vector(s) of the training vector set 210 classified with the negative label. Subsequently received vectors may be classified with reference to the hyperplane 220. As such, the access engine 108 and hyperplane determination engine 110 may support various classification applications, for example in anomaly detection in video streaming, high frequency trading, and fraud detection, as examples.

In determining the hyperplane 220, the hyperplane determination engine 110 may initialize a candidate hyperplane in the form of a vector with a dimensionality equal to the dimensionality of the sparse binary training vectors of the training vector set 210. The dimensionality of a vector may refer to number of vector elements in a vector, and may also be referred to as vector length or vector size. In determining the separating hyperplane for the training vector set 210, the hyperplane determination engine 110 may iteratively adapt the candidate hyperplane vector in successive iterations as various sparse binary training vectors of the training vector set 210 are analyzed and accounted for. In FIG. 2, the hyperplane determination engine 110 initializes the candidate hyperplane vector 231 to have the same dimensionality as the sparse binary training vector 211 and assigns an initial value of ‘0’ to each candidate hyperplane vector element in the candidate hyperplane vector 231.

The hyperplane determination engine 110 may also maintain a scoring vector in determining the separating hyperplane. In FIG. 2, the hyperplane determination engine 110 maintains the scoring vector 232. The scoring vector 232 may track separation variances for each of the sparse binary training vectors with respect to the candidate hyperplane vector 231. A separation variance may refer to a degree at which a particular training vector violates the candidate hyperplane vector 231. The greater the separation variance, the greater the degree the particular training vector violates the candidate hyperplane vector 231. In some examples, the separation variance may account for the label of a particular sparse binary training vector as well as the distance of the particular sparse binary training vector to the candidate hyperplane vector.

The scoring vector 232 may include a number of scoring vector elements equal to the number of sparse binary training vectors in the training vector set 210. Each scoring vector element may track the separation variance of a particular sparse binary training vector in the training vector set 210. In some examples, the separation variance is represented as numerical values and the lower the numerical value of a sparse binary training vector, the greater the degree at which the sparse binary training vector violates the candidate hyperplane vector 231.

In general, the hyperplane determination engine 110 may iteratively adapt the candidate hyperplane vector 231. For each iteration, the hyperplane determination engine 110 may select the sparse binary training vector in the training vector set 210 with a greatest separation variance with respect to candidate hyperplane vector 231 as indicated by the separation variances tracked through the scoring vector 232. Then, the hyperplane determination engine 110 may update the candidate hyperplane vector 231 to account for (e.g., reduce) the separation variance of the selected sparse binary training vector. As the candidate hyperplane vector 231 may change at each iteration, separation variances with respect to the candidate hyperplane vector 231 may also change. The hyperplane determination engine 110 may thus update the scoring vector 232 to recalculate the separation variances in view of any updates to the candidate hyperplane vector 231.

In these update computations to the candidate hyperplane vector 231 and the scoring vector 232, the hyperplane determination engine 110 may exploit the binary and sparse characteristics of the training vector set 210. Matrix product operations to recalculate the distance for each of the training vectors in the training vector set 210 may be used to recalculate separation variances.

However, such matrix computations can be computationally expensive, particularly when the number of training vectors is relatively large (e.g., in the millions or more). However, the sparse binary training vectors used by the hyperplane determination engine 110 may mostly include vector elements with a ‘0’ value, which would reduce or eliminate the effect of many product computations involving such 0-value vector elements.

For example, instead of performing matrix product operations each iteration to update the scoring vector 232, the hyperplane determination engine 110 may instead incrementally update the scoring vector 232. These incremental updates may take into account the particular vector elements of the candidate hyperplane vector 231 updated in a particular iteration, and the hyperplane determination engine 110 may determine the impact of a candidate hyperplane vector update on tracked separation variances. In particular, the hyperplane determination engine 110 may identify any other sparse binary training vectors whose separation variance will be impacted based on an update to the candidate hyperplane vector 231.

For sparse binary training vectors, the number of impacted training vectors may include only the sparse binary training vectors who share a non-zero value at vector indices where updates to the candidate hyperplane vector 231 occurred. Thus, the hyperplane determination engine 110 may perform separation variance update computations specifically for these other sparse binary training vectors sharing a non-zero element at the same vector index or indices updated for the candidate hyperplane vector 231.

As another example, the hyperplane determination engine 110 may incrementally update the candidate hyperplane vector 231. In some implementations, updating of the candidate hyperplane vector 231 to reduce the separation variance of a particular training vector may include summing the candidate hyperplane vector 231 to the particular training vector. As many (e.g., most) of the values of a sparse binary training vector are ‘0’, the hyperplane determination engine 110 may increase the efficiency of such an update by only performing summing operations for the non-zero elements of the sparse binary training vector (and thus foregoing or determining not to perform summing operations for the zero elements of the sparse binary training vector).

The hyperplane determination engine 110 may thus incrementally update the scoring vector 232 and the candidate hyperplane vector 231, which may improve computational efficiency without decreasing classification accuracy. Example implementations of such incremental updates to the scoring vector 232 and candidate hyperplane vector 231 are described next.

Table 1 shown below provides an example computation process for hyperplane determination using sparse binary training vectors. The computation process may implement various elements of the incremental updates described herein, and is shown in the form of pseudo-code. The hyperplane determination engine 110 may implement or execute the example computation process, for example through storing or execution of programmable instructions.

Table 1 is presented below and explained in greater detail herein. Before presenting Table 1, different notations and background for elements included in Table 1 are described. Table 1 is described with reference to a training vector set represented as X={x₁, x₂, . . . X_{N}εR^{U}} with a corresponding set of labels represented as Y={y₁, y₂, . . . y_{N} ε{−1,1}}. For a training vector xᵢ, the identifier i may represent a numerical identifier for the training vector, by which the training vector may be identified or referenced.

In Table 1, a sparse binary vector is represented as the set of vector indices (or coordinates) of its non-zero elements. For example, the following vector (0,0,1,0,1,0,0,0,0,0,)^{T} can be represented as {3,5}. Such a representation may be referred to as the set representation of the vector. For notational convenience in Table 1, for a positive integer T, the term 0_{T} represents a vector of vector length T and all of whose elements have a value of zero. The term tₘₐₓ may represent an iteration parameter specifying a number of iterations to perform. Continuing discussion of the annotations used in Table 1, the vector v represents a candidate hyperplane vector 231 and vector g represents a scoring vector 232 used in the hyperplane determination process.

Various underlying data structures are accessed through functions shown in Table 1. For example, the function minx(g) may return the vector index of the minimal element of the vector g, which may represent the particular sparse binary training vector with the greatest separation variance with respect to the candidate hyperplane vector 231 as currently tracked by the scoring vector 232. If the scoring vector 232 includes more than one minimal element, the minx(g) function may return the index of the first-identified minimal element.

Another example data structure is an index that returns the set representation of a vector. This index is accessed via the non-zero function, also denoted as nz(i) function. The nz(i) function may return the set representation of xᵢ, that is, the set of coordinates of the non-zero vector elements of xᵢ. As noted above, the i identifier of the vector xᵢ may be the numerical identifier of the vector used to identify a particular sparse binary training vector in the training vector set 210.

As yet another example data structure, a reverse index may return the set of vectors which have a non-zero element at a given vector index. The data structure may be accessed via the occurs(c) function, which may return the set of vectors in which c represents a non-zero vector index (e.g., the vector element at vector index c has a non-zero value). The set of vectors may be returned as the set of numerical identifiers for the vectors. To illustrate, the occurs(c) function may return a set of numerical identifiers {1, 3, 5}, which may represent the training vectors {x₁, x₃, x₅} and indicate these training vectors have a non-zero element at vector index c. As noted below, the set of numerical identifiers returned by the occurs(c) function may support indexing into the scoring vector 232 to access scoring vector elements (and separation variances) associated with the set of vectors identified through the occurs(c) function.

With the underlying description presented above, Table 1 is presented next:

TABLE 1
Example Computation Process for Hyperplane
Determination Using Sparse Binary Training Vectors

| | |
|---|---|
| 1: | v := 0_{U} |
| 2: | g := 0_{N} |
| 3: | for t = 1: tₘₐₓ do |
| 4: | m := minx(g) |
| 5: | for all c ε nz(m) do |
| 6: | v[c] := v[c] + yₘ |
| 7: | for all j ε occurs(c) do |
| 8: | g[j] := g[j] + yₘ * yⱼ |
| 9: | end for |
| 10: | end for |
| 11: | end for |
| 12: | w := v |

Next, the example computation process shown in FIG. 1 is described in greater detail with respect to the hyperplane determination engine 110 determining a separating hyperplane for a training vector set of sparse binary training vectors. In implementing the example computation process shown in Table 1, the hyperplane determination engine 110 may initialize a candidate hyperplane vector (line 1) and initialize a scoring vector (line 2), each to have vector elements with an initial value of zero. For a number of iterations specified by the iteration parameter tₘₐₓ (line 3, first for loop), the hyperplane determination engine 110 may identify, according to the scoring vector, a particular sparse binary vector with the greatest separation variance from the candidate hyperplane vector (line 4, through the minx(g) function).

Then, the hyperplane determination engine 110 may identify the vector indices of the non-zero elements of the identified sparse binary training vector (line 5, with the vector indices denoted as c and identified through the nz(m) function). For each of these vector indices (line 5, second for loop), the hyperplane determination engine 110 may update the candidate hyperplane vector elements corresponding to these vector indices (line 6). In some examples, the hyperplane determination engine 110 may update the candidate hyperplane vector by updating a candidate hyperplane vector element indexed by the vector index (v[c] being the hyperplane vector element indexed by vector index c) to account for a label of the particular sparse binary training vector (yₘ). In doing so, the hyperplane determination engine 110 may lessen the separation variance of the identified sparse binary training vector, and thus adapt and train the candidate hyperplane vector.

For each candidate hyperplane vector element updated (e.g., for each vector index c), the candidate hyperplane vector may change, which may thus affect the separation variances of some or all of the sparse binary training vectors in the training vector set. The hyperplane determination engine 110 may incrementally update the scoring vector to account for each update to the candidate hyperplane vector, e.g., each update to a particular vector element of the candidate hyperplane vector. That is, the hyperplane determination engine 110 may incrementally update the scoring vector to adjust separation variances affected by updates to the candidate hyperplane vector.

In doing so, the hyperplane determination engine 110 may utilize the reverse index to identify the other sparse binary vectors that also have a non-zero element at the vector index c (line 7, through the occurs(c) function, which may return the numerical identifiers j for these other sparse binary vectors). For each of the other sparse binary vectors with a non-zero element at the at the vector index c (line 7, third for loop), the hyperplane determination engine 110 may update the particular scoring vector element indexed in the scoring vector by the numeral identifier j (line 8). The hyperplane determination engine 110 may do so to account for a label of the other sparse binary training vector (yⱼ) and a label of the particular sparse binary training vector (yₘ). For sparse binary training vectors in the training set with a zero element at the vector index c (e.g., not identified through the occurs(c) function), the hyperplane determination engine 110 may take no action as the separation variance of these sparse binary training vectors will not change in view of an update to the candidate hyperplane vector at vector index c. Thus, the hyperplane determination engine 110 may selectively and incrementally update the separation variance values of the scoring vector 232.

After tₘₐₓ number of iterations are complete, the hyperplane determination engine 110 may determine the candidate hyperplane vector as the separating vector for the training vector set (line 12, with the separating hyperplane denoted as w). Thus, as described above, the hyperplane determination engine 110 may determine the separating hyperplane of a training vector set including sparse binary training vectors.

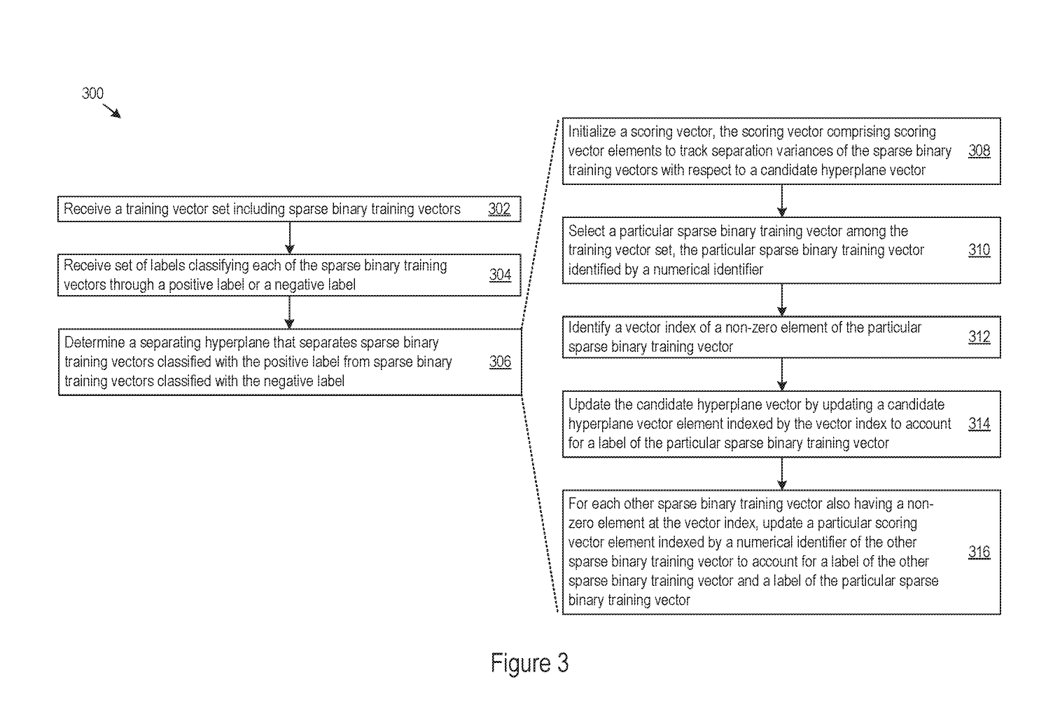

FIG. 3 shows a flow chart of an example method 300 for hyperplane determination through sparse binary training vectors. Execution of the method 300 is described with reference to the access engine 108 and the hyperplane determination engine 110, though any other device, hardware-programming combination, or other suitable computing system may execute any of the steps of the method 300. As examples, the method 300 may be implemented in the form of executable instructions stored on a machine-readable storage medium and/or in the form of electronic circuitry. In some examples, various steps of the method 300 are implemented in a consistent manner or form as the computation process described in Table 1.

In implementing or executing the method 300, the access engine 108 may receive a training vector set including sparse binary training vectors that (302) and receive a set of labels classifying each of the sparse binary training vectors through a positive label or a negative label (304). The sparse binary training vectors may characterize elements of a physical system. In implementing or executing the method 300, the hyperplane determination engine 110 may determine a hyperplane that separates sparse binary training vectors classified with the positive label from sparse binary training vectors classified with the negative label (306). In some examples, the positive label is a ‘1’ value and the negative label is a ‘−1’ value.

In determining the hyperplane, the hyperplane determination engine 110 may perform various steps. As shown in FIG. 3, the hyperplane determination engine 110 may initialize a scoring vector (308). The scoring vector may include scoring vector elements to track separation variances of the sparse binary training vectors with respect to a candidate hyperplane vector. In some implementations, the hyperplane determination engine 110 may initialize the scoring vector prior to other steps in the method 300, such as prior to selecting the particular sparse binary training vector, identifying the vector index, updating the candidate hyperplane vector, and updating the particular scoring vector element (discussed below).

The hyperplane determination engine 110 may also select a particular sparse binary training vector among the training vector set, the particular sparse binary training vector identified by a numerical identifier (310). In some examples, the hyperplane determination engine 110 selects the particular sparse binary training vector responsive to identifying, according to the scoring vector, that the particular sparse binary training vector has a greatest separation variance with respect to the candidate hyperplane vector. As noted above, the hyperplane determination engine 110 may do so through implementing or executing the minx(g) function, particularly when the scoring vector tracks separation variances through numerical values.

Continuing discussion of the method 300, the hyperplane determination engine 110 may identify a vector index of a non-zero element of the particular sparse binary training vector (312). The hyperplane determination engine 110 may identify each of the vector indices of non-zero elements of the particular sparse binary training vector, for example through the set representation of the particular sparse binary training vector as discussed above with reference to the nz( ) function.

Continuing steps that may be part of a hyperplane determination, the hyperplane determination engine 110 may update the candidate hyperplane vector by updating a candidate hyperplane vector element indexed by the vector index to account for a label of the particular sparse binary training vector (314). To do so, the hyperplane determination engine 110 may sum a current value of the candidate hyperplane vector element with the label of the particular sparse binary training vector. The hyperplane determination engine 110 may update each of the candidate hyperplane vector elements of the candidate hyperplane vector indexed by the vector indices of non-zero elements of the particular sparse binary training vector.

In doing so, the hyperplane determination engine 110 may, in effect, add the particular sparse binary training vector (including accounting for the label) to the candidate hyperplane vector. By only performing addition computations for the non-zero elements of the particular sparse binary training vector, the hyperplane determination engine 110 may forego or determine not to perform the vector multiplication computations involving zero-value elements of the particular sparse binary training vector, as these operations would have no impact or effect on summing of the particular sparse binary training vector (including accounting for the label) to the candidate hyperplane vector. As such, the hyperplane determination engine 110 may reduce a number of computations, reduce resource consumption, and increase processing efficiency.

For each other sparse binary training vector training vector also having a non-zero element at the vector index, the hyperplane determination engine 110 may update a particular scoring vector element indexed by a numerical identifier of the other sparse binary training vector to account for a label of the other sparse binary training vector and a label of the particular sparse binary training vector (316). In some examples, the hyperplane determination engine 110 may update the particular vector element by summing a current value of the particular scoring vector element with a product of a label of the particular sparse binary training vector and the label of the other sparse binary training vector.

In some implementations, the hyperplane determination engine 110 may iteratively select the particular sparse binary training vector, identify the vector index, update the candidate hyperplane vector, and update particular scoring vector elements, and do so for a number of iterations specified by an iteration parameter. After the number of iterations have been performed or completed, the hyperplane determination engine 110 may determine the candidate hyperplane vector as the hyperplane that separates the sparse binary training vectors in the training vector set classified with the positive label from the sparse binary training vectors in the training vector set classified with the negative label.

Although one example was shown in FIG. 3, the steps of the method 300 may be ordered in various ways. Likewise, the method 300 may include any number of additional or alternative steps as well, including steps implementing any other aspects described herein with respect to the access engine 108, hyperplane determination engine 110, or combinations thereof.

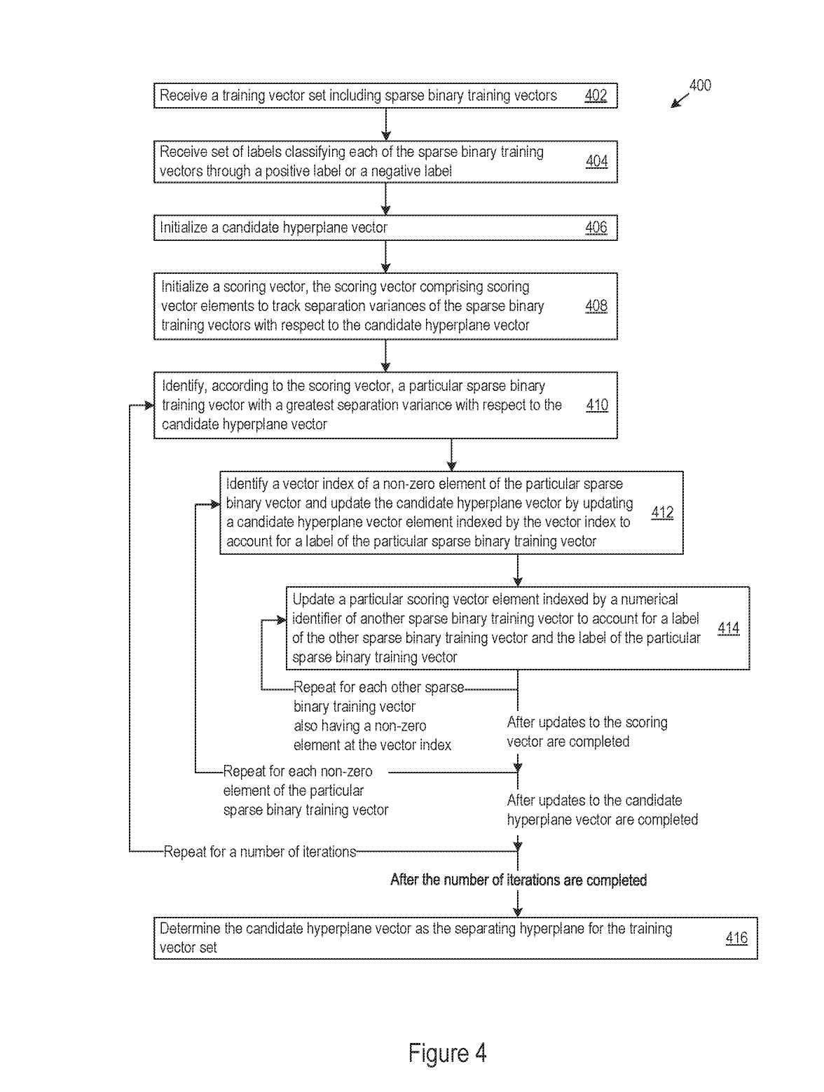

FIG. 4 shows a flow chart of another example method 400 for hyperplane determination through sparse binary training vectors. Execution of the method 400 is described with reference to the access engine 108 and the hyperplane determination engine 110. Though as similarly noted above, any other device, hardware-programming combination, or other suitable computing system may execute any of the steps of the method 400. As examples, the method 400 may be implemented in the form of executable instructions stored on a machine-readable storage medium and/or in the form of electronic circuitry. In some examples, various steps of the method 400 are implemented in a consistent manner or form as the computation process described in Table 1.

The access engine 108 may implement or execute a portion of the method 400, and in doing so may receive a training vector set including sparse binary vectors (402) and receive a set of labels classifying each of the sparse binary training vectors through a positive label (e.g., a ‘1’ value) or a negative value (e.g., a ‘−1’ value) (404). The hyperplane determination engine 110 may also implement portions of the method 400, and in doing so may initialize a candidate hyperplane vector (406) and initialize a scoring vector, the scoring vector comprising scoring vector elements to track separation variances of the sparse binary training vectors with respect to the candidate hyperplane vector (408).

In some implementations, the hyperplane determination engine 110 initializes the candidate hyperplane vector to the same dimensionality of the sparse binary training vectors (e.g., same vector length), and assigns a ‘0’ value to each of the candidate hyperplane vector elements. In initializing the scoring vector, the hyperplane determination engine 110 may set the vector length of the scoring vector as equal to the number of sparse binary training vectors in the training vector set, thus having a scoring vector element for each of the sparse binary training vectors. The hyperplane determination engine 110 may initially assign a ‘0’ value to the scoring vector elements of the scoring vector.

To determine a separating hyperplane for the training vector set, the hyperplane determination engine 110 may identify, according to the scoring vector, a particular sparse binary training vector with a greatest separation variance with respect to the candidate hyperplane vector (410). Then, the hyperplane determination engine 110 may identify a vector index of a non-zero element of the particular sparse binary vector and update the candidate hyperplane vector by updating a candidate hyperplane vector element indexed by the vector index to account for a label of the particular sparse binary training vector (412).

The hyperplane determination engine 110 may update a particular scoring vector element indexed by a numerical identifier of another sparse binary training vector to account for a label of the other sparse binary training vector and the label of the particular sparse binary training vector (414). Such a step may be repeated for each other sparse binary training vector also having a non-zero element at the vector index, thus incrementally updating the scoring vector to account for each of the other sparse binary training vectors also having the non-zero element at the vector index. After such an update of the scoring vector completes, the hyperplane determination engine 110 may repeat step 412 (and thus also iterations of step 414 as well) for each non-zero element of the particular sparse binary training vector. In doing so, the hyperplane determination engine 110 may incrementally update the candidate hyperplane vector (and, in doing so, incrementally update the scoring vector as well). After the incremental updates to the candidate hyperplane vector are completed, the hyperplane determination engine 110 may repeat step 410 (and thus, also iterations of step 412 and further iterations of step 414). The hyperplane determination engine 110 may do so for a number of iterations specified by an iteration parameter. After the number of iterations are completed, the hyperplane determination engine 110 may determine the candidate hyperplane vector as the separating hyperplane for the training vector set (416).

Although one example was shown in FIG. 4, the steps of the method 400 may be ordered in various ways. Likewise, the method 400 may include any number of additional or alternative steps as well, including steps implementing any other features described herein with respect to the access engine 108, hyperplane determination engine 110, or combinations of both.

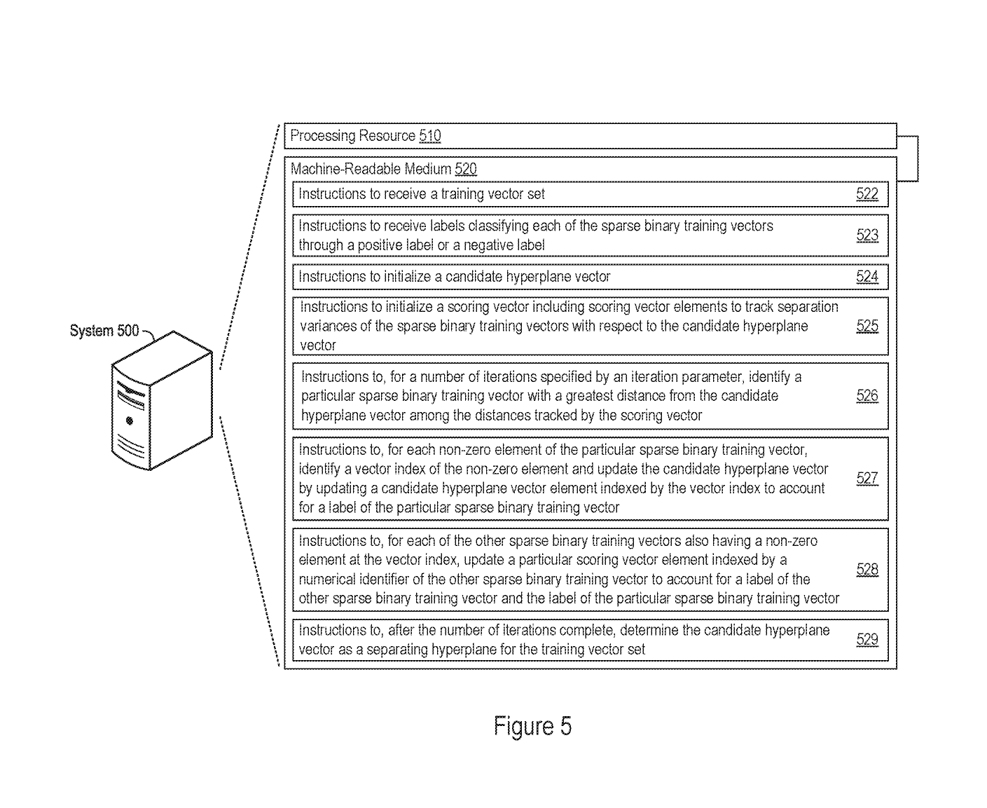

FIG. 5 shows an example of a system 500 that supports generation of feature vectors. The system 500 may include a processing resource 510, which may take the form of a single or multiple processors. The processor(s) may include a central processing unit (CPU), microprocessor, or any hardware device suitable for executing instructions stored on a machine-readable medium, such as the machine-readable medium 520 shown in FIG. 5. The machine-readable medium 520 may be any non-transitory electronic, magnetic, optical, or other physical storage device that stores executable instructions, such as the instructions 522-529 in FIG. 5. As such, the machine-readable medium 520 may be, for example, Random Access Memory (RAM) such as dynamic RAM (DRAM), flash memory, memristor memory, spin-transfer torque memory, an Electrically-Erasable Programmable Read-Only Memory (EEPROM), a storage drive, an optical disk, and the like.

The system 500 may execute instructions stored on the machine-readable medium 520 through the processing resource 510. Executing the instructions may cause the system 500 to perform any of the hyperplane determination features described herein, including according to any features of the access engine 108, the hyperplane determination engine 110, or combinations of both.

For example, execution of the instructions 522, 523, 524, and 525 may cause the system 500 to receive a training vector set comprising sparse binary training vectors that characterize elements of a physical system; receive labels classifying each of the sparse binary training vectors through a positive label or a negative label; initialize a candidate hyperplane vector; and initialize a scoring vector including scoring vector elements to track separation variances of the sparse binary training vectors with respect to the candidate hyperplane vector. Execution of the instructions 526 by the processing resource 510 may cause the system 100 to, for a number of iterations specified by an iteration parameter, identify a particular sparse binary training vector with, according to the scoring vector, a greatest separation variance with respect to the candidate hyperplane vector, the particular sparse binary training vector identified by a numerical identifier.

In these number of iterations, execution of the instructions 527 may cause the system 500 to, for each non-zero element of the particular sparse binary training vector, identify a vector index of the non-zero element and update the candidate hyperplane vector by updating a candidate hyperplane vector element indexed by the vector index to account for a label of the particular sparse binary training vector. For each of the other sparse binary training vectors also having a non-zero element at the vector index, execution of the instructions 528 may cause the system 500 to update a particular scoring vector element indexed by a numerical identifier of the other sparse binary training vector to account for a label of the other sparse binary training vector and the label of the particular sparse binary training vector. As also shown in FIG. 5, execution of the instructions 529 may cause the system 500 to, after the number of iterations have been performed, determine the candidate hyperplane vector as a separating hyperplane for the training vector set.

The systems, methods, devices, engines, and logic described above, including the access engine 108 and the hyperplane determination engine 110, may be implemented in many different ways in many different combinations of hardware, logic, circuitry, and executable instructions stored on a machine-readable medium. For example, the access engine 108, the hyperplane determination engine 110, or both, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine readable instructions stored on the medium, which when executed in an endpoint, computer system, or other device, cause the device to perform operations according to any of the description above, including according to any features of the access engine 108 and the hyperplane determination engine 110.

The processing capability of the systems, devices, and engines described herein, including the access engine 108 and the hyperplane determination engine 110, may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A system comprising:
an access engine to:
access a training vector set comprising sparse binary training vectors that characterize elements of a physical system; and
access a set of labels classifying each of the sparse binary training vectors through a positive label or a negative label; and
a hyperplane determination engine to:
initialize a candidate hyperplane vector;
maintain a scoring vector comprising scoring vector elements to track separation variances of the sparse binary training vectors with respect to the candidate hyperplane vector;
through iterations of identifying, according to the scoring vector, a particular sparse binary training vector with a greatest separation variance with respect to the candidate hyperplane vector:
incrementally update the candidate hyperplane vector; and
incrementally update the scoring vector to adjust separation variances affected by updates to the candidate hyperplane vector.

2. The system of claim 1, wherein the hyperplane determination engine is to incrementally update the candidate hyperplane vector by, for each iteration:
identifying a vector index of a non-zero element of the particular sparse binary training vector; and
updating a candidate hyperplane vector element indexed by the vector index to account for a label of the particular sparse binary training vector.

3. The system of claim 2, wherein the particular sparse binary training vector identified by a numerical identifier; and
wherein the hyperplane determination engine is to incrementally update the scoring vector to adjust affected separation variances by, for each iteration:
for each other sparse binary training vector also having a non-zero element at the vector index:
updating a particular scoring vector element indexed by a numerical identifier of the other sparse binary training vector to account for a label of the other sparse binary training vector and a label of the particular sparse binary training vector.

4. The system of claim 1, wherein the hyperplane determination engine is to maintain the scoring vector by initializing the scoring vector prior to a start of the iterations of identifying the particular sparse binary training vector.

5. The system of claim 1, wherein the hyperplane determination engine is further to, after the iterations are completed:
determine the candidate hyperplane vector as a separating hyperplane that separates sparse binary training vectors classified with the positive label from sparse binary training vectors classified with the negative label.

6. A method comprising:
receiving a training vector set comprising sparse binary training vectors that characterize elements of a physical system;
receiving a set of labels classifying each of the sparse binary training vectors through a positive label or a negative label;
determining a separating hyperplane that separates sparse binary training vectors classified with the positive label from sparse binary training vectors classified with the negative label, wherein determining the hyperplane comprises:
initializing a scoring vector, the scoring vector comprising scoring vector elements to track separation variances of the sparse binary training vectors with respect to a candidate hyperplane vector;
selecting a particular sparse binary training vector among the training vector set, the particular sparse binary training vector identified by a numerical identifier;
identifying a vector index of a non-zero element of the particular sparse binary training vector,
updating the candidate hyperplane vector by updating a candidate hyperplane vector element indexed by the vector index to account for a label of the particular sparse binary training vector; and
for each other sparse binary training vector also having a non-zero element at the vector index:
updating a particular scoring vector element indexed by a numerical identifier of the other sparse binary training vector to account for a label of the other sparse binary training vector and a label of the particular sparse binary training vector.

7. The method of claim 6, wherein the positive label is a ‘1’ value and the negative label is a ‘−1’ value.

8. The method of claim 7, wherein updating a particular scoring vector element indexed by the numerical identifier of the particular sparse binary training vector comprises, for each of the other sparse binary training vectors also having a non-zero element at the vector index:
summing a current value of the particular scoring vector element with a product of a label of the particular sparse binary training vector and the label of the other sparse binary training vector.

9. The method of claim 7, wherein updating the candidate hyperplane vector element indexed by the vector index comprises summing a current value of the candidate hyperplane vector element with the label of the particular sparse binary training vector.

10. The method of claim 6, wherein:
identifying comprises identifying each of the vector indices of non-zero elements of the particular sparse binary training vector; and
updating the hyperplane vector comprises updating each of the candidate hyperplane vector elements of the candidate hyperplane vector indexed by the vector indices of non-zero elements of the particular sparse binary training vector.

11. The method of claim 6, comprising initializing the scoring vector prior to the selecting the particular sparse binary training vector, identifying the vector index, updating the candidate hyperplane vector, and updating the particular scoring vector element.

12. The method of claim 6, comprising selecting the particular sparse binary training vector responsive to identifying, according to the scoring vector, that the particular sparse binary training vector has a greatest separation variance with respect to the candidate hyperplane vector.

13. The method of claim 6, comprising iteratively selecting the particular sparse binary training vector, identifying the vector index, updating the candidate hyperplane vector, and updating the particular scoring vector element for a number of iterations specified by an iteration parameter.

14. The method of claim 13, further comprising, after the number of iterations have been performed:
determining the candidate hyperplane vector as the separating hyperplane that separates the sparse binary training vectors in the training vector set classified with the positive label from the sparse binary training vectors in the training vector set classified with the negative label.

15. A non-transitory machine-readable medium comprising instructions executable by a processing resource to:
receive a training vector set comprising sparse binary training vectors that characterize elements of a physical system;
receive labels classifying each of the sparse binary training vectors through a positive label or a negative label;
initialize a candidate hyperplane vector;
initialize a scoring vector including scoring vector elements to track separation variances of the sparse binary training vectors with respect to the candidate hyperplane vector;
for a number of iterations specified by an iteration parameter:
identify a particular sparse binary training vector with, according to the scoring vector, a greatest separation variance with respect to the candidate hyperplane vector, the particular sparse binary training vector identified by a numerical identifier;
for each non-zero element of the particular sparse binary training vector:
identify a vector index of the non-zero element;
update the candidate hyperplane vector by updating a candidate hyperplane vector element indexed by the vector index to account for a label of the particular sparse binary training vector;
for each other sparse binary training vector also having a non-zero element at the vector index:
update a particular scoring vector element indexed by a numerical identifier of the other sparse binary training vector to account for a label of the other sparse binary training vector and the label of the particular sparse binary training vector; and
after the number of iterations complete:
determine the candidate hyperplane vector as a separating hyperplane for the training vector set.
